(19) United States
(12) Patent Application Publication
(10) Pub. No.: US 2006/0287003 A1
(43) Pub. Date: Dec. 21, 2006

(54) Concomitant inband signaling for data communications over digital wireless telecommunications network

(76) Inventors: Kamyar Moinzadeh, Bellevue, WA (US); David C. Quimby, Seattle, WA (US); Darrin L. Garret, Kingston, WA (US); Leon L. Hong, Bainbridge Island, WA (US)

Correspondence Address: STOEL RIVES LLP, 900 SW FIFTH AVENUE, SUITE 2600, PORTLAND, OR, 97204-1268, US

(21) Appl. No.: 11/154,145

(22) Filed: Jun. 15, 2005

(51) Int. Cl. H04B 1/38

(52) U.S. Cl. 455/557

(57) ABSTRACT

Systems and methods are described to use an inband signaling modem to communicate digital data over a voice channel of a wireless telecommunications network, while simultaneously maintaining the ability to support a voice conversation. An inband signaling modem receives digital data. A voice activity detector receives a digitized voice signal from a codec. The voice activity detector outputs an indication of the degree of confidence that speech is present in the digitized voice signal. If the indication denotes that speech is not present, the inband signaling modem encodes the digital data into audio tones. The synthesized audio tones are sent to a voice channel of a wireless telecommunications network. If the voice activity detector indicates that speech is present, the digitized voice signal is sent to the voice channel of a wireless telecommunications network.

### Copyright Notice

© 2005 AIRBIQUITY, INC. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d).

### TECHNICAL FIELD

This invention is related to wireless telecommunications and more specifically to systems and methods to support the transmission of digital data over the audio channel of a wireless telecommunications network while a voice conversation is in progress.

### BACKGROUND OF THE INVENTION

Systems and methods have been disclosed in the past for transmitting digital data over the voice channel of a wireless telecom network. Voice services have the advantages of low cost, high reliability and wide availability across various wireless networks and technologies. Digital wireless data services by contrast are sometimes unreliable, and can vary in bandwidth, delay and other parameters across different networks and technologies.

Moreover, transmitting data in the voice channel has the characteristic that a voice call connection must be established. This enables substantially simultaneous voice and data communications. Thus, for example, an emergency call taker or concierge operator can talk to a person who requires assistance, and at the same time receive data such as the person's location or physiological or medical data.

The prior art suggests simultaneous transmission of voice and data over a wireless voice channel by carving out a frequency band, using notch filtering, to be used exclusively for data. Other prior art teaches simultaneous voice and data transmission by encoding the digital data into audio frequency tones that will pass through the digital wireless network. Another technique is called “blank and burst”—it calls for “blanking” or muting the audio voice channel for a brief interval, and then transmitting the digital data (in the form of audio tones) over the channel during that interval. Hopefully, the data interval is short enough to not interfere with the voice conversation. The need remains for improvements in this field to enable digital data transfer through the voice channel of a digital wireless network concomitantly with a voice conversation and without interrupting the voice conversation.

### SUMMARY

In one embodiment, an input receives digital data for transmission through the wireless voice channel. A voice activity detector determines that speech is being generated from the local end of the audio channel. An inband signaling modem modulates digital data into synthesized tones. A controller gives priority to speech over modem tones for transmission over the voice channel of a digital wireless telecommunications network. A modem activity detector determines that synthesized tones are present in the incoming audio at the remote end of the audio channel. A second controller mutes the audio so that modem tones are not heard in the voice conversation. A second inband signaling modem demodulates the synthesized tones into digital data. An output transmits digital data that has been received over the network.

Additional aspects and advantages will be apparent from the following detailed description of preferred embodiments, which proceeds with reference to the accompanying drawings.

### BRIEF DESCRIPTION OF THE DRAWINGS

FIG. 1 is a diagram showing a wireless telecommunications network that provides concomitant inband signaling from a wireless node to a modem bank according to one embodiment of the invention.

FIG. 2 is a diagram showing concomitant inband signaling from a modem bank to a wireless node according to another embodiment of the invention.

FIG. 3 is a diagram showing bidirectional concomitant inband signaling between a wireless node and a modem bank according to another embodiment of the invention.

### DETAILED DESCRIPTION OF PREFERRED EMBODIMENTS

Preliminarily, it should be noted that the drawing figures are not strictly hardware or software diagrams. Rather, most of the elements shown in the figures will involve a combination of hardware and software in a practical implementation. The present invention can be implemented in various combinations of hardware and software, subject to numerous detailed design choices, all of which should be deemed within the scope of the invention.

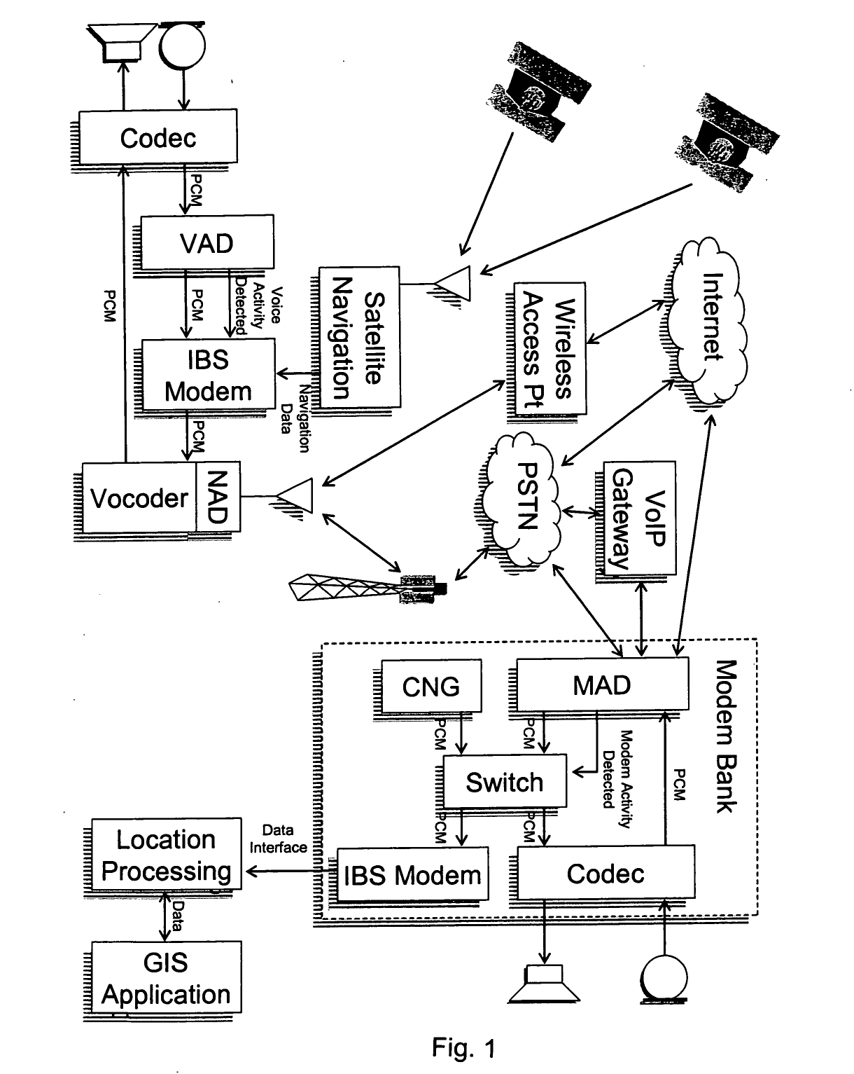

FIG. 1 illustrates a wireless telecommunications network with a concomitant inband signaling (CIBS) modem transmitting to a modem bank, in accordance with the invention. An analog voice signal is digitized by a coder-decoder (codec) using Pulse Code Modulation (PCM) and sent to a Voice Activity Detector (VAD). The VAD algorithm detects the presence of speech in the voice signal and transmits the voice activity status to an IBS modem. Broadcasts from a plurality of Global Positioning System (GPS) satellites, Global Orbiting Navigation Satellite System (GLONASS) satellites, and GALILEO satellites are received by a Global Navigation Satellite System (GNSS) receiver and processed into navigation data. Periodically, the navigation data is transmitted from the satellite navigation receiver to the IBS modem. If the VAD determines that silence or noise is present in the voice signal and digital data to be transmitted exists, the IBS modem encodes the navigation data into synthesized audio tones to be passed to a Network Access Device (NAD). If speech is present, the IBS modem passes the unmodified voice signal to the NAD.

The NAD either communicates to a wireless telecommunications network as a circuit switched call or to a wireless internet access point as an Internet Protocol (IP) packet switched Voice Over Wireless LAN (VoWLAN) call. The digital wireless telecommunications network and the wireless internet access point require that the audio PCM signal be processed by a voice coder (vocoder) to reduce the bandwidth required for transmission. The vocoder compresses the information associated with human speech by using predictive coding techniques. The call can be routed from the Public Switched Telephone Network (PSTN) to the IP network or vice versa.

The call is received at the modem bank by a Modem Activity Detector (MAD). The MAD processes the incoming PCM audio and detects the presence of synthesized audio tones through an algorithm analyzing signal energy and frequency content. If the MAD determines that synthesized tones are not present, the modem activity status is used to control a telephony switch to route the audio to a codec for transformation to an analog voice signal. If the MAD detects synthesized audio tones, the modem activity status is used to route the audio through the telephony switch to an IBS modem. Simultaneously, audio noise from a Comfort Noise Generator (CNG) is routed by the telephony switch to the codec.

The IBS modem decodes the synthesized audio tones into digital navigation data. The navigation data is passed to a location processing algorithm that filters and validates the incoming data based on past samples of a multiplicity of navigation information types including timestamp, location, ground speed, and ground track angle. The navigation data is then output to a Geographic Information System (GIS) application for reverse geocoding and display.

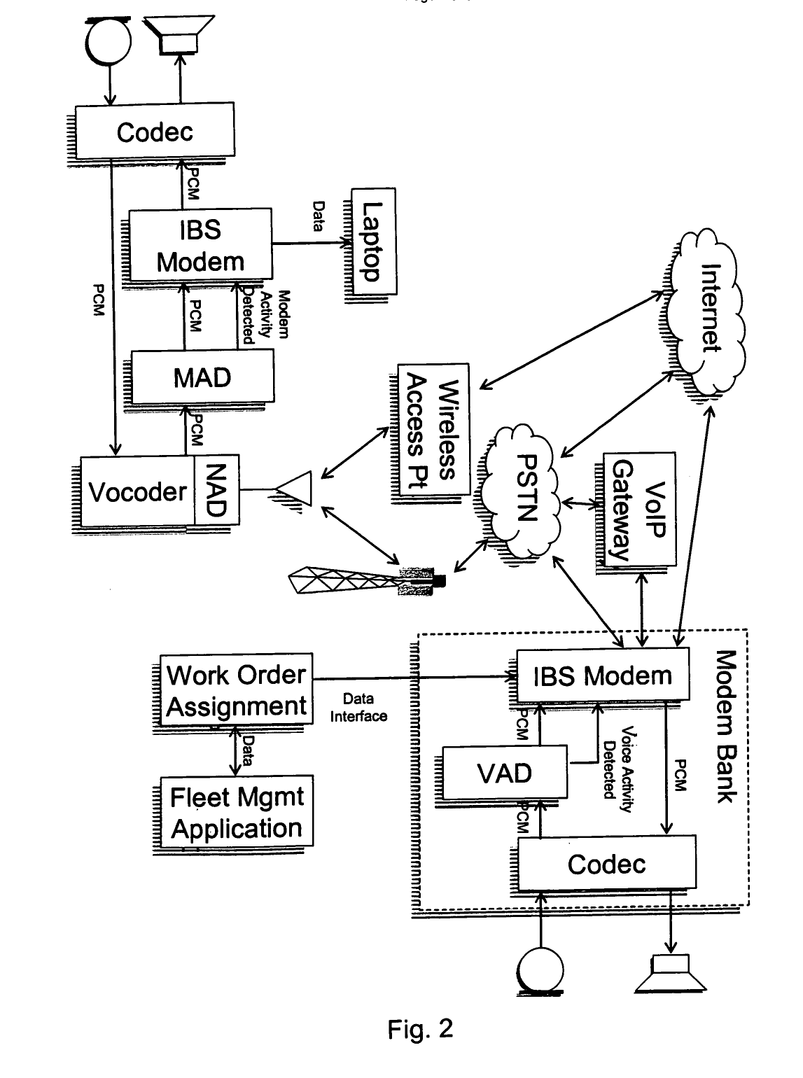

FIG. 2 shows an instance of the CIBS modem within a modem bank transmitting to a wireless node, in accordance with the invention. In a similar manner to FIG. 1, an analog voice signal is digitized by a codec and sent to a VAD using PCM. The VAD speech detection algorithm indicates the presence of speech to the IBS modem and if speech is present, the unmodified voice signal is passed to the telecommunications network as a circuit switched call or as a series of IP packets in a Voice Over IP (VoIP) call. If the VAD determines that speech is not present and digital data from another application, such as a fleet management application, is to be transmitted, the IBS modem encodes the digital data into synthesized audio tones for transmission over the telecommunications network.

The NAD receives the call where the vocoder reconstitutes the coded voice signal into an audio PCM signal. The PCM audio is processed by a MAD that detects the synthesized audio tones from the modem bank and provides the modem activity status to the IBS modem. If the MAD indicates that synthesized tones are not present, the IBS modem forwards the PCM audio to the codec for conversion to an analog signal that can be played over a speaker. If synthesized tones are present, the IBS modem mutes the incoming audio by sending PCM audio that represents silence to the codec. The IBS modem then decodes the tones into the digital data, such as a work order assignment, sent by the application. This data is sent to a mobile computing platform, such as a laptop computer.

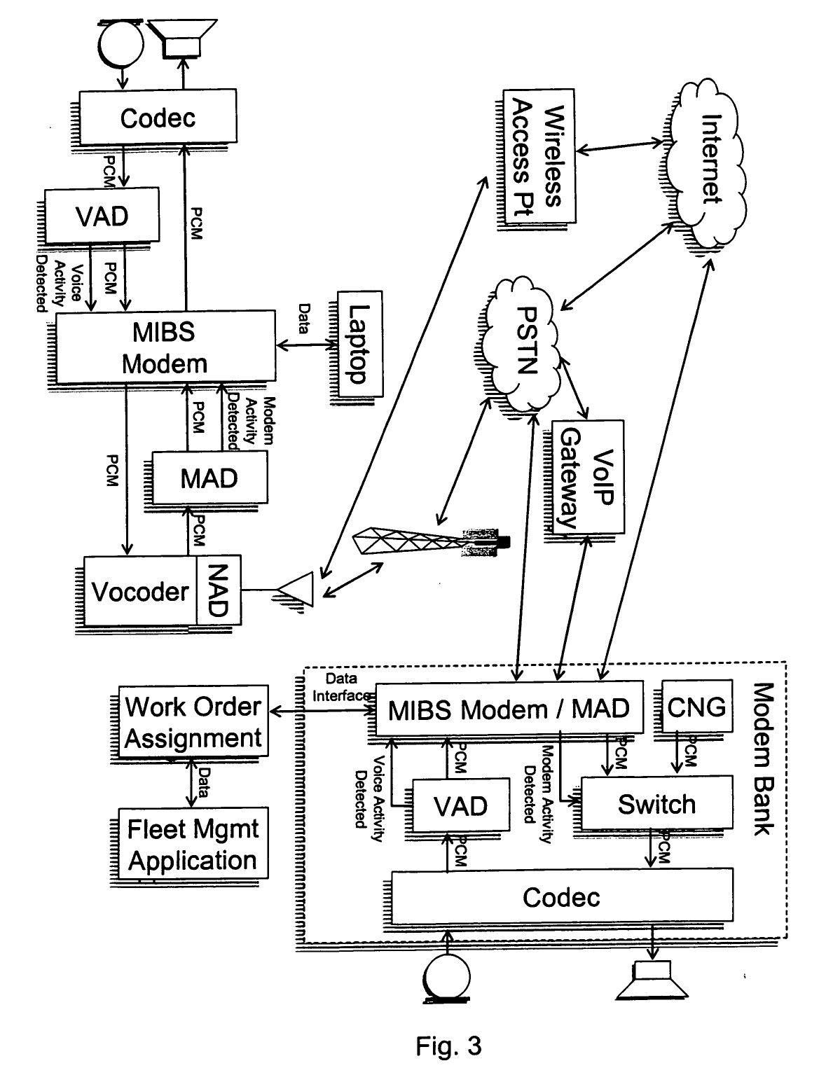

FIG. 3 represents elements present in FIGS. 1 and 2 to enable digital data to be transmitted bidirectionally by using Multichannel Inband Signaling (MIBS) modems. By using a first pair of frequencies to modulate digital data to be transmitted in one channel and using a second pair of frequencies to modulate digital data to be transmitted in the opposite direction in another channel, a full-duplex communication link can be established between the modem bank and the wireless node.

For digital data to be transmitted from the wireless node to the modem bank, the codec digitizes an analog voice signal into PCM audio. The VAD determines if speech is present in the PCM audio and passes the voice activity status to the MIBS modem. If speech is present, the MIBS modem passes it to the vocoder. Otherwise it modulates the digital data received from the mobile computing platform into synthesized audio tones and passes them to the vocoder for transmission over the telecommunications network via the NAD.

The modem bank receives the call from the wireless node and routes the audio to a combined MAD/MIBS modem. The MAD determines if modem activity is present and passes the status to a switch. If modem activity is not present, the audio PCM is routed to the codec for conversion to an analog audio signal that may be played on a speaker. If synthesized audio tones are present, the MIBS modem demodulates the digital data and passes it to the destination application. The switch receives status that modem activity is present and passes PCM audio from the CNG to the codec for conversion to an analog signal to be played on a speaker.

For digital data to be transmitted from the modem bank to the wireless node, the VAD analyzes the PCM audio from the codec that represents the analog voice signal and generates a voice activity status signal. If speech is present, the combined MAD/MIBS modem forwards the PCM audio to the telecommunications network without alteration. Otherwise, the MIBS modem modulates the digital data received from the application using a set of synthesized audio tones that are different from those generated by the MIBS modem in the wireless node. These synthesized audio tones are transmitted over the telecommunications network over a plurality of networks such as the PSTN, the internet using VoIP and local area networks using VoWLAN.

The NAD receives the audio from the telecommunications network and forwards it to the vocoder which reconstitutes the signal into audio PCM. The audio PCM is analyzed by a MAD that provides status to the MIBS modem that synthesized tones are present. If synthesized tones are not present, the PCM audio is passed to the codec without change and converted to an analog signal for playing on a speaker. Otherwise, the MIBS modem passes PCM audio that represents silence to the codec, resulting in silence being reproduced at the speaker. The MIBS modem demodulates the audio based on the second set of synthesized audio tone frequencies and passes the digital data to the mobile computing platform.

It will be obvious to those having skill in the art that many changes may be made to the details of the above-described embodiments without departing from the underlying principles of the invention. The scope of the present invention should, therefore, be determined only by the following claims.

1. A concomitant inband signaling modem system for communicating digital data over a voice channel of a wireless telecommunications network, comprising:
a wireless network access device;
a first inband signaling modem that transmits data using a first audio tone having a first frequency and a second audio tone having a second frequency;
a second inband signaling modem that receives data using a first audio tone having a first frequency and a second audio tone having a second frequency;
a first codec to convert analog voice signals to digital audio data;
a second codec to convert digital audio data to analog voice signals;
a voice activity detector providing a voice activity indicator;
a controller that controls when the sending inband signaling modem transmits data based on the voice activity indicator.

2. A system according to claim 1 wherein the wireless network access device is mobile.

3. A system according to claim 2 further comprising: a plurality of navigation sensors to supply data to be transmitted by the first inband signaling modem.

4. A system according to claim 3 wherein the data include time, location, speed, velocity, acceleration, heading and track angle.

5. A system according to claim 3 wherein the navigation sensors include satellite navigation receivers, inertial reference units.

6. A system according to claim 3 further comprising: a location processing engine to filter and validate data received by the second inband signaling modem.

7. A system according to claim 1 further comprising:
a modem activity detector providing a modem activity indicator;
a second controller that controls when the audio to the second codec is muted based on the modem activity indicator.

8. A system according to claim 7 further comprising: a comfort noise generator to supply audio to the second codec.

9. A system according to claim 7 further comprising: a first inband signaling modem using a third audio tone having a third frequency to indicate start of transmission and using a fourth audio tone having a fourth frequency to indicate end of transmission; a modem activity detector using a third audio tone having a third frequency to assist detection of start of modem activity and using a fourth audio tone having a fourth frequency to assist detection of end of modem activity.

10. A system according to claim 1 wherein the first inband signaling modem uses an unacknowledged simplex protocol to send data.

11. A concomitant inband signaling modem system for bidirectional digital data communication over a voice channel of a wireless telecommunications network, comprising:
a wireless network access device;
a first multichannel inband signaling modem;
a second multichannel inband signaling modem;
a first codec to convert between analog voice signals and digital audio data;
a second codec to convert between analog voice signals and digital audio data;
a first voice activity detector providing a first voice activity indicator;
a second voice activity detector providing a second voice activity indicator;
a first controller that controls when the first multichannel inband signaling modem transmits data based on the first voice activity indicator;
a second controller that controls when the second multichannel inband signaling modem transmits data based on the second voice activity indicator;
a first modem activity detector providing a first modem activity indicator;
a second modem activity detector providing a second modem activity indicator;
a third controller that controls when the audio to the first codec is muted based on the first modem activity indicator;
a fourth controller that controls when the audio to the second codec is muted based on the second modem activity indicator.

12. A method of digital data transfer through the voice channel of a digital wireless network concomitantly with a voice conversation and without interrupting the voice conversation, comprising the steps of:
receiving digitally encoded voice data;
receiving digital data for transmission in the voice channel of a call;
detecting whether or not voice activity is currently present in the digitally encoded voice data; and
if voice activity is not currently detected in the digitally encoded voice data, transmitting the digital data in the voice channel of the call.

13. A method according to claim 12 and further comprising:
continuing to monitor the received digitally encoded voice data to detect whether or not voice activity is currently present in the digitally encoded voice data; and
if voice activity is currently present in the digitally encoded voice data;
discontinuing the said transmitting the digital data in the voice channel of the call.

14. A method according to claim 13 and wherein the digital data comprises location data.

15. A method according to claim 13 and wherein the digital data include an indication of at least one of time, location, speed, velocity, acceleration, heading and track angle.

16. A method according to claim 13 and wherein the digital data includes an indication of an automobile air-bag deployment.

17. A method according to claim 13 and wherein the digital data includes an indication of an automobile alarm condition.
